(19) United States
(12) Patent Application Publication
(10) Pub. No.: US 2011/0226405 A1
(43) Pub. Date: Sep. 22, 2011

(54) FUNCTIONAL FILM MANUFACTURING METHOD

(75) Inventor: Hiroyuki NISHIDA, Kanagawa (JP)

(73) Assignee: FUJIFILM CORPORATION, Tokyo (JP)

(21) Appl. No.: 13/050,441

(22) Filed: Mar. 17, 2011

(30) Foreign Application Priority Data
Mar. 17, 2010 (JP) 2010-060486

(51) Int. Cl. B32B 37/02

(52) U.S. Cl. 156/152

(57) ABSTRACT

A method of manufacturing a functional film by using a laminated material obtained by adhering a protective film to a substrate to form a film on the substrate is provided. The protective film is peeled off from the substrate, and the substrate and the protective film are fed in the longitudinal direction along different transporting paths, and the surface to be treated is treated while the substrate is fed, after which the treated substrate and the protective film are again adhered. Protection of the substrate and the functional layer can be achieved, and manufacturing costs can be reduced.

### BACKGROUND OF THE INVENTION

This invention relates to a method of manufacturing a functional film such as a gas barrier film. More specifically, this invention relates to a method of manufacturing a functional film that can protect the surface of a substrate or a formed gas barrier layer, etc., at low cost.

Gas barrier films, formed by deposition of a gas barrier layer (water-vapor barrier layer) on a substrate, are used not only in such positions or parts requiring moisture resistance in various apparatuses and devices including optical devices, displays such as liquid-crystal displays and organic EL displays, semiconductor manufacturing apparatuses, and thin-film solar cells, but also in packaging materials used to package food, clothing, electronic components, etc.

Known gas barrier layers include ones made of various inorganic compounds such as silicon nitride, silicon oxide, silicon oxynitride and aluminum oxide. Further, these gas barrier layers are formed by vacuum film formation method such as plasma-enhanced CVD, sputtering, vacuum evaporation, etc.

Functional films obtained by forming, on the surface of a substrate, a film exhibiting the intended function, such as light reflection, prevention of light reflection, surface protection, etc. (hereinafter referred to as “functional layers” for sake of convenience), have been used in various applications, not limited to gas barrier films.

Further, as a method of producing such functional films which enables manufacturing with high productivity or production efficiency, apparatuses which form films by the so-called roll-to-roll system are known, wherein a web of a substrate or a lengthy substrate is fed from a substrate roll having the substrate wound into a roll and transported in its longitudinal direction while a gas barrier layer, etc., is formed on the substrate, and the substrate having the film formed thereon is wound into a roll.

In production of the gas barrier film obtained by forming a gas barrier layer made from an inorganic compound described above, the surface of the substrate on which the gas barrier layer is formed must be kept smooth and clean in order to obtain a gas barrier film having high gas barrier performance. Further, it is preferred that the surface of the substrate on which the functional layer is formed is clean, without limitation to production of gas barrier films. Additionally, to produce a suitable product, it is also important that damage to the functional layer, such as the formed gas barrier layer, is prevented.

To achieve these objectives, the surface of the substrate on which the functional layer is to be formed or the surface of the formed functional layer is protected by a protective film.

For example, in WO 2007/138837, it is stated that in production of a gas barrier film using a roll-to-roll system, a gas barrier layer is formed on surface A of a substrate by atmospheric pressure plasma-enhanced CVD while the substrate is transported in the longitudinal direction while being wound around a drum electrode, after which a protective film (adhesive resin material) is adhered on top of the gas barrier layer and this is wound into a roll, and then this substrate roll is loaded with the front and back reversed, and a gas barrier layer is formed on surface B.

According to this production method, the protective film is adhered on top of the gas barrier layer of surface A, thereby preventing damage to the gas barrier layer of surface A due to contact with the drum electrode when the gas barrier layer of surface B is formed.

Further, it is stated in WO 2007/138837 that in production of the gas barrier film having a gas barrier layer on both surfaces as described above, the protective film of surface A may be peeled off before winding the substrate on which the gas barrier layer was formed on surface B.

Additionally, it is also stated in WO 2007/138837 that a protective film is adhered to surface A of the substrate before the gas barrier layer is formed on surface A, and the protective film is peeled off before it is transported to the film formation area. In WO 2007/138837, it is stated that, according to this method, foreign matter attached to the substrate surface may be removed before formation of the gas barrier layer, and a gas barrier film with excellent homogeneity can be produced.

By adhering a protective film on the substrate surface before film formation or on the surface of the formed functional layer in this way, damage to the substrate surface on which the functional layer is to be formed or damage to the formed functional layer can be prevented, and a functional film that properly exhibits the intended functions can be produced.

Thus, as stated in WO 2007/138837, the protective film that protects the substrate or functional layer is peeled off before formation of the functional layer or before winding the treated substrate into a roll. In production of functional films, the protective film that has been peeled off is normally discarded.

That is, when both protection of the substrate and protection of a functional layer are required, two protective films are required. Further, when a plurality of layers of functional layers are formed, protective films in a number corresponding to the number of functional layers that require protection are required.

For this reason, the cost of these protective films causes the cost of the functional films to increase, particularly functional films obtained by formation of a plurality of functional layers.

An objective of the present invention is to solve the problems as described above, and to provide a method of manufacturing a functional film obtained by forming a functional layer exhibiting the intended functions on a substrate surface, wherein the substrate surface before film formation, the formed functional layer and the like can be protected, thereby appropriately preventing damage caused by contact with other components, and moreover, the increase in production costs arising from the protective films can be suppressed.

### SUMMARY OF THE INVENTION

In order to achieve the above object, according to the present invention, there is provided a method of manufacturing a functional film by treating a surface to be treated of a web of a substrate of a laminated material obtained by adhering a protective film on said surface to be treated of said substrate, including: peeling off said protective film from said substrate; transporting said substrate and protective film in a longitudinal direction along different transporting paths; treating said surface to be treated while transporting said substrate to form said functional film; and then re-adhering the thus treated substrate and said protective film to cover said surface to be treated with said protective film to form a re-adhered laminated material.

In the method of manufacturing a functional film according to the present invention, it is preferable that the treating step is a step of depositing on said surface to be treated of said substrate. Further, it is preferable that tension cutting means is disposed on a transporting path of said protective film between a peeling position where said protective film is peeled off from said substrate to a re-adhering position where said protective film is re-adhered to said substrate, and blocks tensile forces that act on the protective film in said transporting path before and after said tension cutting means is disposed. Further, it is preferable that the following expression (1) is satisfied

T3<T1<T2 (1)

where T1 denotes a tensile force acting on said substrate, T2 denotes a tensile force acting on said protective film from said peeling position to a position of said tension cutting means, and T3 denotes a tensile force acting on said protective film from said position of said tension cutting means to said re-adhering position. Further, it is preferable that the treating step a step of treating said surface to be treated of said substrate under a reduced pressure; wherein said protective film is transported in the longitudinal direction from said peeling position to said re-adhering position under the reduced pressure in said transporting step. Further, it is preferable that the treating step is a step of treating said surface to be treated of said substrate under a pressure of 1000 Pa or below. Further, it is preferable that a pressure in a transporting path of said protective film from said peeling position to said re-adhering position is the same as a treatment pressure of said surface to be treated of said substrate. Further, it is preferable to include adjusting a temperature of said protective film during transporting of said protective film. Further, it is preferable that the adjusting step is a step of adjusting said temperature of said protective film such that a temperature difference between said substrate and said protective film at said re-adhering position is 20° C. or less. Further, it is preferable that the re-adhering step is a step of re-adhering said substrate and said protective film while holding temperatures of said substrate and said protective film at or below their respective glass transition temperatures, respectively. Further, it is preferable that the peeling step is a step of peeling off said protective film from said substrate at or below a softening temperature of an adhesive material of said protective film. Further, it is preferable to include unwinding said laminated material from a substrate roll in which a web of said laminated material was wound into a roll to feed said laminated material to said peeling step; and winding again into a roll said re-adhered laminated material transported from said re-adhering step, wherein said peeling step of said substrate and said protective film of said fed laminated material, said treating step of said substrate, and said re-adhering step of said treated substrate and said protective film while transporting said substrate are performed and then said re-adhered laminated material is sent to said winding step. Furthermore, it is preferable that protective film is cleaned in said transporting path of said protective film by cleaning means of said protective film provided on said transporting path of said protective film.

In the functional film production method of the present invention, using a lengthy laminated material obtained by adhering a protective film to a substrate surface (substrate surface to be treated), the protective film is peeled off from the substrate while the laminated material is transported, after which the substrate and the protective film are transported along different transporting paths and treatment such as gas barrier layer formation on the substrate is performed, and then the protective film is again adhered to the treated substrate.

For this reason, according to the production method of the present invention, exposure of the substrate surface or the formed functional layer can be reduced to the required minimum, such as during film formation, etc., and the surfaces requiring protection are reliably protected, thereby greatly inhibiting damage caused by contact with other components and preventing a reduction in characteristics arising from damage, etc., and a high-quality product can be stably produced. Further, even in production of functional films obtained by forming a plurality of layers of films, protection of the substrate surface and protection of the surface of the functional layers such as a formed gas barrier layer can be performed by one protective film.

For this reason, according to the present invention, the substrate surface and the surface after treatment can be suitably protected, and additionally, even in production of functional films obtained by forming a plurality of layers of functional layers, the protection can be achieved by a single protective film, and increases in production costs arising from protective films can be greatly suppressed.

### BRIEF DESCRIPTION OF THE DRAWINGS

FIG. 1 is a schematic view showing an embodiment of the film formation apparatus for implementing the functional film production method of the present invention.

FIG. 2A is a schematic view showing an embodiment of the laminated material used in the functional film production method of the present invention, and FIG. 2B is a schematic view showing an embodiment of the laminated material after film formation on the substrate was performed by the functional film production method of the present invention.

FIG. 3 is a schematic view showing another embodiment of the film formation apparatus for implementing the functional film production method of the present invention.

### DETAILED DESCRIPTION OF THE INVENTION

Next, the method of producing a functional film according to the present invention is described in detail by referring to the preferred embodiments shown in the accompanying drawings.

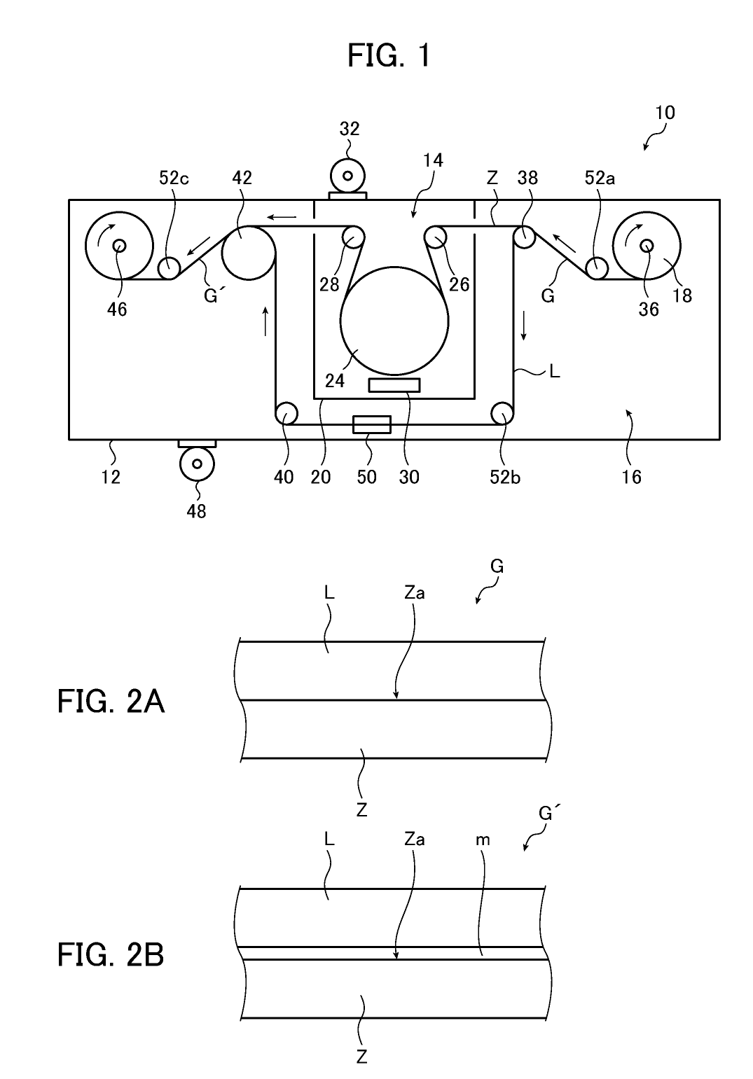

FIG. 1 is a schematic view showing an embodiment of the film formation apparatus for implementing the functional film production method of the present invention.

In the film formation apparatus 10 shown in FIG. 1, using a laminated material G comprising a substrate Z and a protective film L, the substrate Z and the protective film L are peeled, and transported at the same speed along different transporting paths, and a layer which exhibits the intended function such as a gas barrier layer (hereinafter referred to as “functional layer m” for the sake of convenience) is formed on the substrate Z, after which the substrate Z and the protective film L are again adhered. The film formation apparatus 10 comprises a vacuum chamber 12, and a film formation chamber 14 and an unwinding/winding chamber 16 formed inside the vacuum chamber 12.

In the illustrated film formation apparatus 10, the laminated material G is long, and it is wound into a roll and loaded into the film formation apparatus 10 as a laminated material roll 18.

The film formation apparatus 10 is an apparatus which performs film formation by the so-called roll-to-roll system, wherein the laminated material G is pulled out from the laminated material roll 18, and while it is transported in the longitudinal direction, the predetermined treatments such as peeling, film formation and adhesion as described above are performed, and it is again wound into a roll.

In the functional film production method of the present invention, as shown in FIG. 2A, a functional film is produced using the laminated material G, in which the entire front surface (surface to be treated) Za of the substrate Z is covered with the protective film L, and the substrate Z and protective film L are laminated and adhered.

In the present invention, as the substrate Z on which the functional layer is formed, any web-shaped material on which the functional layer m can be formed may be used without particular limitation, in accordance with the formed functional layer m and its formation method.

Specific examples of the substrate Z that may be advantageously used include plastic (resin) films made of organic materials such as polyethylene terephthalate (PET), polyethylene naphthalate, polyethylene, polypropylene, polystyrene, polyamide, polyvinyl chloride, polycarbonate, polyacrylonitrile, polyimide, polyacrylate, and polymethacrylate, and metal web-shaped materials such as aluminum and stainless steel.

Further, in the present invention, web-shaped materials in which these plastic films are used as the base, on top of which layers (films) are formed to obtain various functions, such as a protective layer, an adhesive layer, a light-reflecting layer, a light-shielding layer, a planarizing layer, a buffer layer, a stress-relief layer and a gas barrier layer, may be also used as the substrate Z.

In this case, a web-shaped material in which only one layer is formed on the base may be used as the substrate Z, or a web-shaped material in which a plurality of layers are formed on the base may be used as the substrate Z. Also, if the substrate Z is a web-shaped material in which a plurality of layers are formed on the base, there may be a plurality of the same layer. For example, a layer which combines two or more layers may be laminated repeatedly multiple times, so as to form a configuration in which a combination of a planarizing layer and a gas barrier layer is laminated repeatedly multiple times.

Additionally, if a substrate Z in which one or more layers are formed on a base to obtain some sort of function, the one or more layers may be layers formed by the production method of the present invention.

That is, in the production method of the present invention, a laminated material G′ (refer to FIG. 2B) produced by the production method of the present invention, in which a functional layer m is formed on a substrate Z and a protective film L is laminated and adhered on top of it, may be used as the laminated material G which serves as the starting material.

On the other hand, the protective film L protects the front surface Za of the substrate Z, and further, after formation of the functional layer m, it protects the functional layer m.

As the protective film L, various adhesive protective films used in production of functional films may be used without particular limitation.

For example, a protective film L obtained by coating the front surface of a plastic film such as polyethylene film with an adhesive material is shown as an example. Further, a protective film L obtained by coating a web-shaped material having a porous form with an adhesive material may also be used.

As the adhesive material, various Known adhesive materials may be used without particular limitation, such as ethylene-vinyl acetate copolymer-based adhesives, polyolefin-based adhesives, acrylic-based adhesives, rubber-based adhesives, urethane-based adhesives, silicon-based adhesives, ultraviolet-curable adhesives, etc.

This type of protective film L is described in detail in WO 2007/138837.

Another suitable example of the protective film L is one in which an adhesive layer is formed on the surface of a plastic film by co-casting (co-extrusion) of a plastic film and a substance capable of melt-deposition as the adhesive.

By using a protective film L in which the adhesive layer is provided by co-casting when the plastic film itself is melt-deposited, rather than the adhesive material being applied afterward, more optimal adhesive strength can be attained, and in addition, the amount of adhesive material remaining on the front surface Za of the substrate Z when the protective film L is peeled off from the laminated material G can be reduced, thereby enabling production of a high-quality functional film. Further, by using a protective film L in which the adhesive layer is formed by co-casting, outgassing from the adhesive material can be reduced, thereby minimizing adverse effects when handled in a vacuum system as illustrated, and further inhibiting adverse effects on film formation due to excess gas, such as generation of defects such as cracks and voids in the functional layer m.

In the present invention, the thickness of the protective film L is not particularly limited, but 10 to 300 micrometers is preferred.

Further, the peel strength of the protective film L is not particularly limited, but if the adhesive strength of the protective film L is too high, particularly when handled in a vacuum system as illustrated, there is the possibility of the front surface Za being fractured by the peeling of the protective film L due to increased adhesive strength due to removal of air between it and the substrate Z (front surface Za), and furthermore, there is also the possibility that adhesive material will remain on the front surface Za and become a contaminant when the functional layer m is formed. Conversely, if the adhesive strength of the protective film L is too weak, the protective film L does not adhere nicely to the substrate Z, and this causes wrinkles or abnormalities in the appearance of the roll.

Considering the above points, it is preferred that the peel strength of the protective film L with respect to the front surface Za of the substrate Z is 0.4-5 N/m. In particular, when the protective film L is handled in a vacuum system as illustrated, in which winding breakage occurs, it is preferred that the peel strength of the protective film L with respect to the front surface Za of the substrate Z is 0.4-2.4 N/m.

Further, considering protection of the substrate Z and functional layer m and the prevention of transfer of surface irregularities of the protective film L to the substrate Z, the rigidity of the protective film L (its base) is generally lower than that of the substrate Z (its base).

As described above, in the film formation apparatus 10, using a laminated material G, in which the protective film L is adhered and laminated by covering the entire front surface Za of the substrate Z, the laminated material G is fed out from the laminated material roll 18, and the substrate Z and the protective film L are peeled, and the two are transported in the longitudinal direction along different transporting paths while the functional layer m is formed on the substrate Z, after which the substrate Z on which film formation has been completed and the protective film L are again adhered, and this laminated material is wound into a roll.

The production apparatus 10 includes a film formation chamber 14 and an unwinding/winding chamber 16 (called “unwinding chamber 16” hereinafter), which are formed inside a vacuum chamber 12. In addition to the illustrated components, the film formation apparatus 10 (60) may also have various other components provided in film formation apparatuses that perform film formation by the roll-to-roll system, including sensors, and components (transporting means) for transporting the substrate Z along a predetermined path, as exemplified by transporting roller pairs and guide components for adjusting the position in the width direction of the substrate Z.

The film formation chamber 14 is a part where a functional layer m such as a gas barrier layer is formed on the front surface Za of the substrate Z by a known vacuum film formation method, and it is separated in a substantially air-tight manner from the unwinding chamber 16 by a partition wall 20 inside the vacuum chamber 12.

In the illustrated embodiment, the film formation chamber 14 includes a drum 24, transporting rollers 26 and 28, film formation means 30 and vacuum evacuation means 32.

In the film formation chamber 14, the substrate Z transported from the unwinding chamber 16, from which the protective film L was peeled by the peeling roller 38 described below, is guided to the drum 24 by the transporting roller 26, and while the substrate Z is transported in the longitudinal direction while being wound onto a predetermined region of the drum 24, the functional layer m is formed (deposited) by the film formation means 30, and the substrate Z on which film formation has been completed is guided by the transporting roller 28 and transported to an adhesion roller 42 of the unwinding chamber 16 described below.

The drum 24 is a cylinder which transports the substrate Z in the longitudinal direction while positioning it in a predetermined film formation position.

The drum 24 preferably has built-in temperature adjustment means which can adjust the temperature of the substrate Z during film formation. As the temperature adjustment means, various known means, such as circulation means of temperature adjustment media such as silicon oil and water, heating means such as various heaters, and cooling means such as piezoelectric elements, may be used without particular limitation.

Further, if the film formation means 30 is one that uses an electrode pair such as CCP-CVD, the drum 24 preferably acts as the opposing electrode of the film formation means 24. To do so, a bias power supply (for example, 400 Hz pulse power supply or RF power supply) may be connected to the drum 24, or it may be grounded, or the connection to a bias power supply and ground may be switched.

The vacuum evacuation means 32 sets the inside of the film formation chamber 14 to a predetermined pressure in accordance with the formation of the functional layer m.

The vacuum evacuation means 32 is not particularly limited, and exemplary means that may be used include vacuum pumps such as a turbo pump, a mechanical booster pump, a dry pump, and a rotary pump, assist means such as a cryogenic coil, and various other known (vacuum) evacuation means which use means for adjusting the ultimate degree of vacuum or the amount of air discharged and are employed in vacuum film formation apparatuses. In this regard, the same holds true for the vacuum evacuation means 48 described below.

The film formation means 30 forms the functional layer m on the front surface Za of the substrate Z by a known vacuum (reduced-pressure) film formation method.

The film formation method of the functional layer m in the present invention is not particularly limited, and any known vacuum film formation, such as CVD, plasma-enhanced CVD, sputtering, vacuum evaporation and ion plating, may be used. Accordingly, the film formation means 30 includes various components in accordance with the film formation method performed in the film formation chamber 14.

For example, when the film formation chamber 14 forms the functional layer m by ICP-CVD method (inductively coupled plasma-enhanced CVD), the film formation means 30 includes an induction coil for forming an induced magnetic field, and gas supply means for supplying raw material gas to the film formation region.

When the film formation chamber 14 forms the functional layer m by CCP-CVD method (capacitively coupled plasma-enhanced CVD), the film formation means 30 includes a shower head electrode which serves as an electrode which is hollow and has a large number of small holes and as a raw material gas supply unit, an RF power supply (13.56 MHz, etc.) which supplies plasma excitation power, a raw material gas supply source, etc.

When the film formation chamber 14 forms the functional layer m by sputtering, the film formation means 30 includes means for supporting a target, an RF electrode, and means for supplying a sputtering gas. When the film formation chamber 14 forms the functional layer m by reactive sputtering, the film formation means 30 includes a means for supplying the reactive gas.

When the film formation chamber 14 forms the functional layer m by vacuum evaporation, the film formation means 30 includes an evaporation source (crucible), and means for heating the formed material such as an electron gun or resistance heating power supply.

In the present invention, as the formed functional layer m, various functional layers m that they can be formed by the vacuum film formation methods described above may be used without particular limitation.

Examples include gas barrier layers such as silicon nitride, silicon oxide, silicon oxynitride and aluminum oxide.

Although described in detail below, in the present invention, cleanliness and flatness of the surface of the substrate Z can be maintained by the protective film L, and furthermore, the formed functional layer m can also be protected by the protective film L.

Accordingly, the present invention can be advantageously used in formation of a functional layer m wherein cleanliness and smoothness of the film formation surface or prevention of damage to the formed functional layer m are required in order to obtain a high-quality product. For example, it can be advantageously used in formation of a gas barrier layer (that is, production of a gas barrier film) in which strength is required.

In the film formation chamber 14 in the present invention, film formation is preferably performed at a pressure of 1000 Pa or below.

Although described in detail below, in the film formation apparatus 10, attachment of foreign matter such as dust to the protective film L can be suitably prevented by setting the film formation pressure within the above range, since the film formation chamber 14 and the unwinding chamber 16 are kept at the same pressure during film formation.

An example of film formation at pressure of 1000 Pa or below is formation of a functional layer m wherein a silicon nitride film is formed as a gas barrier layer by CCP-CVD, using raw material gases of silane, ammonium, hydrogen and nitrogen, an RF power supply of frequency 13.56 MHz (plasma excitation power supply), a bias power supply of frequency 400 Hz, and a pressure of about 20 Pa.

Further, since sputtering is normally performed at a pressure of 10 Pa or below, it may be advantageously used for film formation of any material.

The illustrated film formation chamber 14 has only one film formation means 30 facing the drum 24, but the present invention is not limited thereto, and a functional layer m having a plurality of layers may be formed by providing a plurality, such as two or three, film formation means 30 facing the drum 24 in the circumferential direction (that is, the direction of transporting of the substrate Z).

Further, a functional layer m having a plurality of layers may be formed by arranging a plurality of drums in the film formation chamber, and arranging one or more film formation means 30 for each drum.

If a plurality of film formation means 30 are arranged in this way, each film formation means 30 may perform the same method of film formation or different methods of film formation.

Additionally, if a plurality of drums are used, by arranging a drum which acts as coating means or flash evaporation means described below, a drum which performs vacuum film formation and a pressure chamber, etc., film formation may be performed continuously under vacuum in the following sequences: flash evaporation→vacuum film formation→flash evaporation, flash evaporation→vacuum film formation, vacuum film formation→flash evaporation.

The unwinding chamber 16 is a part in which the laminated material G is fed out from the laminated material roll 18, the substrate Z and the protective film L are peeled, the substrate Z is transported to the film formation chamber 14, the protective film L is transported via a predetermined path outside the film formation chamber 14, and the substrate Z which has undergone film formation and has been discharged from the film formation chamber 14 and the protective film L are re-adhered and wound into a roll.

This type of unwinding chamber 16 includes a supply shaft 36, a peeling roller 38, a preheating roller 40, an adhesion roller 42, a winding shaft 46, vacuum evacuation means 48, a tension cutter 50 and transporting rollers 52 (52a-52c).

The vacuum evacuation means 48 keeps the pressure inside the unwinding chamber 16 and the pressure inside the film formation chamber 14 (film formation pressure) at the same pressure during film formation of at least the functional layer m.

The film formation chamber 14 and the unwinding chamber 16 are separated in a substantially air-tight manner by a partition wall 20 as described above, and the two chambers are connected at the part where the substrate Z passes through. If there is a pressure differential, the pressure of the unwinding chamber 16 may adversely affect the film formation pressure of the film formation chamber 14.

In contrast, by keeping the pressure of the unwinding chamber 16 and the pressure of the film formation chamber 14 at the same pressure by the vacuum evacuation means 48, the pressure of the unwinding chamber 16 adversely affecting film formation of the functional layer m in the film formation chamber 14 can be prevented.

In the film formation apparatus 10, to prevent the gas inside the film formation chamber 14 from being exhausted into the unwinding chamber 16 and the inside of the unwinding chamber being contaminated, the pressure of the unwinding chamber 16 may be raised about 1-10 Pa above the pressure of the film formation chamber 14.

In the present invention, the pressures of the film formation chamber 14 and unwinding chamber 16 being the same means that they are substantially the same while taking into consideration unavoidable fluctuations or errors, and also includes the case where there is a pressure differential for preventing contamination as described above.

As described above, in the film formation apparatus 10, the laminated material G in which the substrate Z and the protective film L are adhered is wound into a roll, and loaded as the laminated material roll 18.

The supply shaft 36 is a rotating support shaft on which the laminated material roll 18 is loaded.

The laminated material G fed out from the laminated material roll 18 is guided by the transporting roller 52a and supplied to the peeling roller 38.

The peeling roller 38 is a known peeling roller which peels laminated material obtained by adhering a plurality of lengthy web-shaped materials on a roller. The laminated material G is peeled by the peeling roller 38 to form the substrate Z and the protective film L.

When the substrate Z and the protective film L are peeled by the peeling roller 38, the temperature of the laminated material G is preferably at or below the softening temperature of the adhesive material of the protective film L, and in particular, room temperature is preferred.

By this configuration, a desirable result is obtained, in that transfer of the adhesive material to the substrate Z can be suitably prevented.

The substrate Z peeled by the peeling roller 38, as described above, is transported to the film formation chamber 14, and a functional layer m such as a gas barrier layer is formed by the film formation means 30. It is then guided by the transporting roller 28 and discharged from the film formation chamber 14, and supplied to the adhesion roller 42.

On the other hand, the protective film L is guided by the transporting roller 52b and preheating roller 40, is passed along a predetermined path outside the film formation chamber 14, and is supplied to the adhesion roller 42. A tension cutter 50 is arranged between the transporting roller 52b and the preheating roller 40. The tension cutter 50 and the preheating roller 40 will be described in detail later.

In transporting of the substrate Z and the protective film L from the peeling roller 38 to the adhesion roller 42, the transporting speeds of the substrate Z and the protective film L are the same.

The adhesion roller 42 is a known adhesion roller of web-shaped material which laminates and adheres two lengthy web-shaped materials, at least one of which has adhesive properties, on a roll. Further, the adhesion roller 42 also serves as the temperature adjustment means of the protective film L.

As shown in FIG. 1, the substrate Z and the protective film L are laminated and re-adhered by the adhesive roller 42 such that the protective film L covers the entire surface of the functional layer m, to form the laminated material G′ as shown in FIG. 2B.

The laminated material G′ is guided along a predetermined path by the transporting roller 52c, and is wound into a roll by the winding shaft 46. The winding tension by the winding shaft 46 is not particularly limited, but is preferably about 10-100 N/m as per studies by the inventors.

As is clear from the above descriptions, in the production method of the present invention, in production of a functional film using the laminated material G obtained by adhering the protective film L on the front surface Za of the substrate Z, the protective film L peeled off from the substrate is transported along a transporting path different from that of the substrate Z, the functional layer m is formed on the substrate Z, and the substrate Z and the protective film L are laminated such that the functional layer m is covered.

That is, by the production method of the present invention, exposure of the substrate surface or the formed functional layer can be reduced to the required minimum, such as during film formation and before and after it. For this reason, according to the production method of the present invention, the surfaces requiring protection are reliably protected, and there is no decrease in characteristics caused by damage due to contact with other components such as transporting rollers and adhesion of dust, etc., and a high-quality product can be stably produced.

Additionally, in the illustrated embodiment, it is wound in the state where the protective film L is laminated on the substrate Z on which the functional layer m has been formed. For this reason, the functional layer m can remain in the protected state even after winding, thereby preventing so-called back surface transfer, wherein damage arising from contact of the back surface of the substrate Z, which generally has high rigidity, with the functional layer m or surface irregularities of the back surface of the substrate are transferred to the functional layer m.

Further, since the protective film L peeled from the substrate Z is reused, protection of the front surface Za of the substrate Z and protection of the formed functional layer m can be performed by one protective film L.

Moreover, this can be achieved by a single protective film L in production of a laminated material G′ having a protective film L and a substrate Z which has a functional layer m produced by the production method of the present invention, and also in production of functional films obtained by forming a plurality of functional layers m by performing film formation, etc., of functional layers m by the production method of the present invention, and therefore, increases in production costs arising from protective films can be greatly suppressed.

Further, in film formation at atmospheric pressure, such as atmospheric pressure plasma-enhanced CVD, if it is attempted to reuse the protective film L as in the present invention, foreign matter such as dust floating in the transporting space ends up becoming attached to the surface of the protective film L (particularly the adhesive surface) during transporting of the peeled protective film L, and the functional layer m ends up being contaminated and damaged by this foreign matter.

In contrast, as described above, in the illustrated film formation apparatus 10, the film formation chamber 14 performs film formation under reduced pressure, and in order to keep the film formation chamber 14 at a suitable film formation pressure, the unwinding chamber 16 which feeds the protective film L is set to the same pressure as the film formation chamber 14. That is, in the film formation apparatus 10, foreign matter such as dust can be prevented from attaching to the protective film L being transported in the state where it has been peeled from the substrate Z, because the protective film L is also transported under reduced pressure. In particular, by setting the film formation pressure in the film formation chamber 14 to 1000 Pa or below as described above, attachment of foreign matter such as dust to the protective film L can be suitably prevented, and a high-quality functional film can be more stably produced.

In the present invention, if necessary, means for cleaning the adhesive surface (or both surfaces) of the protective film L may be provided along the transporting path of the protective film L from the peeling roller 38 to the adhesion roller 42. By so doing, the surface of the protective film L can be cleaned and re-adhered to the substrate Z more reliably.

The cleaning means for the protective film L is not particularly limited, and various types of known cleaning means for web-shaped materials, such as cleaning rollers having adhesive properties, may be used.

In the illustrated film formation apparatus 10, a tension cutter 50 is arranged along the transporting path of the protective film L between the transporting roller 52b and the preheating roller 40. The tension cutter 50 blocks tensile forces that act on the protective film L on the upstream side and downstream side (transporting direction of the protective film L), and makes it possible to convert the tensile forces acting on the protective film L on the upstream side and downstream side of the tension cutter 50 into different tensile forces.

Further, in the film formation apparatus 10, the transporting roller 52a and the preheating roller 40 also serve as tension controllers which adjust the tensile forces acting on the protective film L.

Additionally, tension measurement means (tension pickup) for measuring the tensile forces acting on the substrate Z and protective film L (in particular, T1, T2 and T3 described below) may be arranged in the film formation apparatus 10.

By having a tension cutter 50 and tension controllers in the film formation apparatus 10, the tension of the substrate Z and the protective film L is optimized when the substrate Z and the protective film L are peeled and when the substrate Z and the protective film L are re-adhered.

As an example, T1 is taken as the tension acting on the substrate Z, T2 is taken as the tension acting on the protective film L from the peeling roller 38 to the tension cutter 50, and T3 is taken as the tension acting on the protective film L from the tension cutter 50 to the adhesion roller 42. In the film formation apparatus 10, the tensile forces acting on the protective film L between the peeling roller 38 and the adhesion roller 42 are blocked by the tension cutter 50, and the tensile forces acting on the protective film L upstream and downstream from the tension cutter 50 are adjusted by the tension controllers. As a result, the tensile forces acting on the substrate Z and the protective film L are adjusted such that T3<T1<T2.

As described above, the protective film L is generally less rigid than the substrate Z.

For this reason, when the protective film L is peeled off from the substrate Z while the laminated material G is being transported, it is necessary to apply strong tension to the protective film L to peel it reliably. Conversely, if strong tensile forces act on the protective film L when the substrate Z and the protective film L are adhered, there end up being wrinkles in the protective film L in the longitudinal direction, and adhesion cannot be performed properly.

In contrast, by providing a tension cutter 50 and tension controllers along the transporting path of the protective film L as illustrated, and setting the tensile forces acting on the substrate Z and the protective film L such that T3<T1<T2, peeling of the substrate Z and the protective film L can be reliably performed, and additionally, wrinkling of the protective film L when the substrate Z and the protective film L are re-adhered can be prevented, thereby enabling proper adhesion (formation of the laminated material G′).

As the tension cutter 5C, any known tension cutter that can block the tensile forces acting on lengthy web-shaped material being transported and can convert the tensile forces acting on the web-shaped material before and after it (upstream and downstream of it) to different tensile forces at a predetermined location, such as a nip roller or dancer roller, may be used without particular limitation.

A tension cutter 50 which can properly block the tensile forces acting on the protective film L and does not damage the protective film L is preferably selected.

Further, as the tension adjustment means of the protective film L using the transporting roller 52b and preheating roller 40, any known tension adjustment method of lengthy web-shaped material being transported, such as roller position adjustment, may be used without particular limitation.

Various tension adjustment means other than tension adjustment using rollers may also be used in the present invention.

The respective strengths of T1, T2 and T3 and their differences are not particularly limited, and may be set as appropriate in accordance with the rigidity of the substrate Z and the protective film L, the difference in rigidity between the substrate Z and the protective film L, the thickness of the substrate Z and the protective film L, the transporting speed of the substrate Z and the protective film L, the adhesion properties of the protective film L, etc.

As described above, a preheating roller 40 which also serves as a tension controller is arranged downstream of the tension cutter 50. Further, the adhesion roller 42 also serves as a temperature adjustment means of the protective film L.

In the illustrated film formation apparatus 10, re-adhesion of the substrate Z on which the functional layer m has been formed and the protective film L can be performed more properly due to there being such temperature adjustment means of the protective film L.

As described above, a film is formed on the front surface Za of the substrate Z by a vacuum film formation method such as plasma-enhanced CVD, sputtering or vacuum evaporation in the film formation chamber 14. When vacuum film formation is performed by such methods, the temperature of the substrate Z normally ends up rising. Further, there are also cases where film formation is performed while increasing the film formation temperature in the state where the substrate has been heated, in order to form a high-duality film that more properly exhibits the intended function.

On the other hand, peeling of the substrate Z and the protective film L is preferably performed at room temperature, and no treatment is performed after peeling until re-adhesion with the substrate Z.

That is, in vacuum film formation, there are cases where heating of the substrate Z is unavoidable during the process. Therefore, if no other treatment is performed, there is a temperature difference between the substrate Z and the protective film L when they are re-adhered.

If the substrate Z and the protective film L are re-adhered in the state where there is such a temperature difference, rapid temperature changes occur in the protective film L and the substrate Z, and as a result, the protective film L, which has low rigidity, ends up becoming wrinkled, and a proper product cannot be obtained.

In contrast, in the film formation apparatus 10, the adhesion roller 42 also serves to adjust the temperature of the protective film L, and in addition, due to the fact that there is a preheating roller 40, the protective film L is heated before being adhered to the substrate Z, thereby reducing the temperature difference between it and the substrate Z.

For this reason, according to the film formation apparatus 10, wrinkling of the protective film L when the substrate Z and the protective film L are re-adhered can be prevented, and proper adhesion can be performed.

The temperature difference when the substrate Z and the protective film L are re-adhered is preferable 20° C. or less, and 5° C. or less is particularly preferred.

By setting the temperature difference when the substrate Z and the protective film L are re-adhered within the above range, the generation of wrinkles in the protective film L during re-adhesion can be more reliably prevented.

When the substrate Z and the protective film L are re-adhered, it is preferred that the temperatures of the substrate Z (including each layer in the case where the substrate Z has one or more layers on a base) and the protective film L are at or below their respective glass transition temperatures. Such a configuration is preferred because it can prevent curling of the laminated material G′ during transporting due to the difference in contraction rates while cooling to room temperature from the temperature during adhesion, which leads to peeling of the protective film L from the laminated material G′ such that the desired protective effect cannot be obtained, and because it can prevent feeding problems and winding problems. Further, it is also preferred because when the laminated material G′ is cut into sheets at the final product stage, it can similarly prevent curling and peeling of the protective film L. That is to say, it can prevent problems in product handling.

Therefore, the above temperature adjustment by the adhesion roller 42 and the preheating roller 40 is preferably performed such that the temperature of the protective film L is not higher than its glass transition temperature. Further, to keep the temperature of the substrate Z to be re-adhered below its glass transition temperature, means of cooling the substrate Z may be arranged upstream from the adhesion roller 42 as necessary, and this cooling means may be used in adjustment of the temperature difference when the substrate Z and the protective film L are re-adhered.

As the heating method of the protective film L in the adhesion roller 42 and the preheating roller 40, various known means, such as circulation of a heating medium inside the rollers or incorporating heaters in the rollers, may be used.

Further, to perform sufficient heating of the protective film L, it is preferably assured that a sufficient amount of the protective film L is wound on the adhesive roller 42. To do so, it is preferred that the adhesion roller 42 is a roller with a relatively large diameter. For example, a roller having a diameter of at least 250 mm is preferred.

The preheating roller 40 may be provided as necessary, and in cases where sufficient temperature adjustment of the protective film L can be performed by the adhesion roller 42, an ordinary transporting roller 52 (also serving as a tension controller) may be used instead of the preheating roller 40.

The operation of the film formation apparatus 10 shown in FIG. 1 will be described.

The lengthy laminated material G is loaded onto the supply shaft 36 as a laminated material roll 18 which has been wound into a roll. Once the laminated material roll 18 has been loaded on the supply shaft 36, the laminated material G is pulled out, and the substrate Z and the protective film L are passed along the predetermined transporting paths where they are peeled by the peeling roller 38. The substrate Z is transported to the adhesion roller 42 after passing through the film formation chamber 14, and the protective film L is transported to the adhesion roller 42 after passing through the transporting roller 52b and the preheating roller 40. They are adhered by the adhesion roller 42, and reach (are wound around) the winding shaft 46.

Once feeding of the laminated material G (substrate Z and protective film L) has been completed, the vacuum chamber 12 is closed, the vacuum evacuation means 32 and 48 are started up, and evacuation of the film formation chamber 14 and the unwinding chamber 16 is started.

In parallel, preparation for film formation in the film formation means 30 is started. For example, if the film formation means 30 performs film formation by CCP-CVD or sputtering, supply of the raw material gas is begun, and if it performs film formation by vacuum evaporation, heating of the formed material is begun.

Once the pressure of the film formation chamber 14 and the unwinding chamber 16 have reached the predetermined pressure and preparation of the film formation means 30 is complete, transporting of the laminated material G (feeding from the laminated material roll 18 and winding by the winding shaft 46) is begun, and film formation onto the substrate Z is also started. For example, if the film formation means 30 performs film formation by CCP-CVD or sputtering, supply of the plasma excitation power, etc., is begun, and if it performs film formation by vacuum evaporation, the shutter of the evaporation source is opened.

The laminated material G fed out from the laminated material roll 18 is fed to the peeling roller 38 via the transporting roller 52a, and the substrate Z and the protective film L are peeled by the peeling roller 38.

While the substrate Z, which has been peeled from the protective film L, is being transported in the longitudinal direction into the film formation chamber 14 and wound on the drum 24 by the transporting roller 26, a predetermined functional layer m, such as a gas barrier layer, for example, is formed by the film formation means 30.

The film formation conditions in the film formation chamber 14 may be set as appropriate in accordance with the film formation means 30, the formed functional layer m, the thickness, the film formation rate, etc.

While being transported on the drum 24, the substrate Z on which the functional layer m has been formed is guided by the transporting roller 28, discharged from the film formation chamber 14 and transported to the adhesion roller 42.

On the other hand, the protective film L, which has been peeled from the substrate Z by the peeling roller 38, is guided by the transporting roller 52b and the preheating roller 40, and transported to the adhesion roller 42.

During this transporting, the protective film L is heated by the preheating roller 40. Further, the tension of the protective film L is adjusted so as to satisfy the condition T3<T1<T2 by the tension cutter 50, and the transporting roller 52b and preheating roller 40, which also serve as tension controllers. By so doing, peeling by the peeling roller 38 and subsequent re-adhesion by the adhesion roller 42 are performed properly as described above.

The substrate Z and the protective film L which have been transported to the adhesion roller 42 are laminated and adhered by the adhesion roller 42 such that the functional layer m is covered by the protective film L.

The protective film L is also heated during transporting by the adhesion roller 42, and the temperature difference between the substrate Z and the protective film L is preferably 20° C. or less, and more preferably 5° C. or less. By so doing, re-adhesion by the adhesion roller 42 is performed properly as described above.

The laminated material G′, consisting of the re-adhered protective film L and substrate Z on which the functional layer m has been formed, is guided to the winding shaft 46 by the transporting roller 52c, wound into a roll by the winding shaft 46, and then supplied to the next process.

As the next process, the laminated material G′, consisting of the protective film L and substrate Z on which the functional layer m has been formed, may be supplied to an apparatus which similarly forms a functional layer m by the production method of the present invention, as described above.

The film formation apparatus 10 forms the functional layer m on the front surface Za of the substrate Z by vacuum film formation, but this invention is not limited thereto, and may also be used in the case where the functional layer m is formed on the substrate Z at atmospheric pressure, as in film formation of the functional layer m by coating.

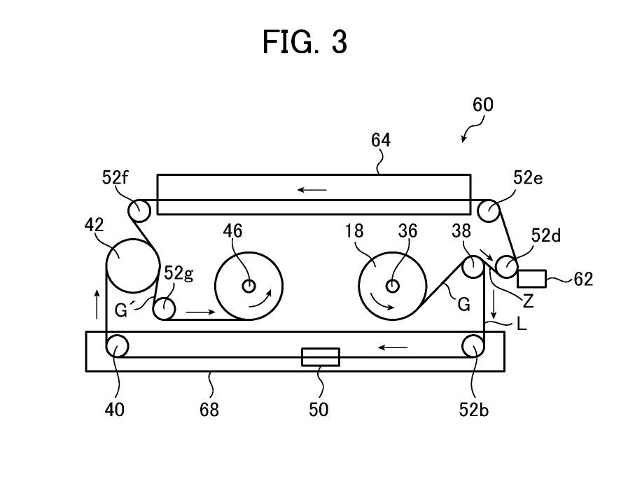

FIG. 3 schematically shows an embodiment of the present invention used in a film formation apparatus that performs coating.

The film formation apparatus 60 shown in FIG. 3 is basically an apparatus similar to the film formation apparatus 10 shown in FIG. 1. Since it uses many of the same components, like components are given like reference signs, and the description below describes mainly the parts that differ, together with the operation of the film formation apparatus 60.

Similar to the film formation apparatus 10, the film formation apparatus 60 also uses a laminated material G consisting of the substrate Z and the protective film L, and it peels the substrate Z and the protective film L, and transports them at the same speed along different transporting paths, and forms the functional layer m on the substrate Z, after which it again adheres the substrate Z and the protective film L.

In the film formation apparatus 60, the laminated material G fed out from the laminated material roll 18 is peeled by the peeling roller 38 to form the substrate Z and the protective film L.

On the substrate Z peeled from the protective film L by the peeling roller 38, the front surface Za is coated by coating means 62 with paint containing the formed material that becomes the functional layer m.

The coating method of the paint used in the coating means 62 is not particularly limited, and various known methods can be used, as exemplified by roll coating, gravure coating, knife coating, dip coating, curtain flow coating, spray coating and bar coating.

While the substrate Z on which the functional layer m has been formed is guided by the transporting roller 52e, the paint is dried by drying means 64, the functional layer m is formed, and then it is guided by the transporting roller 52f and transported to the adhesion roller 42.

The drying means 64 is not particularly limited, and any known drying means such as drying with a heater or warm air (hot air) drying may be used.

In the film formation apparatus 60, flash evaporation means may be provided instead of the coating means 62 and drying means 64.

The flash evaporation means forms on the substrate Z a liquid containing the formed material such as a monomer of an organic compound (oligomer) under reduced pressure, by spraying it on heating means in the form of a fine liquid, evaporating by the heating means, and attaching the vapor of the formed material on the substrate Z.

Further, if the functional layer m is formed by polymerization of a monomer or oligomer of an organic compound by ultraviolet radiation, light radiation or electron beam radiation, a UV lamp, halogen lamp, ion beam radiation means, etc., may be provided downstream from the drying means 64 (flash evaporation means).

On the other hand, the protective film L, which has been peeled from the substrate Z by the peeling roller 38, is guided by the transporting roller 52 and the preheating roller 40, and transported inside a clean zone in which the air (gas) in the space has been cleaned, and it is transported to the adhesion roller 42.

The film formation apparatus 60 forms the functional layer m at atmospheric pressure, but by passing the protective film L which has been peeled from the substrate Z through a clean zone in which the internal air has been cleaned, foreign matter such as dust can be prevented from attaching to the protective film L, and contamination of and damage to the functional layer m caused thereby can be prevented, similar to the film formation apparatus 10 in which the protective film L passes through reduced pressure.

The cleanliness of the clean zone is not particularly limited, and the higher the cleanliness the better, but according to studies by the inventors, attachment of dust to the protective film L can be prevented as long as the degree of cleanliness is class 10 or less. Additionally, a more desired result is obtained if a known static electricity removal apparatus is also provided.

Further, the clean zone may be cleaned by the same known means used in clean rooms in semiconductor manufacturing plants, such as circulation of air through dust filters.

The substrate Z and the protective film L which have been transported to the adhesion roller 42 are laminated and adhered by the adhesion roller 42 such that the functional layer m is covered by the protective film L, to form the laminated material G′, consisting of the substrate Z on which the functional layer m has been formed and the protective film L, as shown in FIG. 2B.

The fact that the protective film L is heated by the preheating roller 40 and adhesion roller 42 up until adhesion by the adhesion roller 42, and the fact that the temperature difference between the substrate Z (temperature rise by drying) and the protective film L is preferably 20° C. or less, and also, the fact that the tension of the protective film L is adjusted so as to satisfy the condition T3<T1<T2 by the tension cutter 50 and the transporting roller 52b and preheating roller 40, which also serve as tension controllers, are the same as in the film formation apparatus 10 described above.

Further, in the film formation apparatus 60 as well, if necessary, cleaning means for the adhesive surface (or both surfaces) of the protective film L may be provided along the transporting path of the protective film L from the peeling roller 38 to the adhesion roller 42.

While the method of manufacturing a functional film according to the present invention has been described above in detail, the present invention is by no means limited to the foregoing embodiments and it should be understood that various improvements and modifications may of course be made without departing from the scope and spirit of the invention.

For example, in the above embodiments, a functional layer m such as a gas barrier layer was formed on the front surface Za of the substrate Z, but the present invention is not limited thereto. For example, surface modification, surface roughening treatment, activation treatment, etc., may be performed by plasma radiation, etc., on the front surface of the substrate Z, rather than film formation of the functional layer m.

The present invention may be advantageously used in the manufacture of various functional films obtained by forming a film that exhibits a function, such as a gas barrier layer or anti-reflective layer, on the surface of a substrate, such as in the manufacture of a gas barrier film.

What is claimed is:

1. A method of manufacturing a functional film by treating a surface to be treated of a web of a substrate of a laminated material obtained by adhering a protective film on said surface to be treated of said substrate, comprising:
peeling off said protective film from said substrate;
transporting said substrate and protective film in a longitudinal direction along different transporting paths;
treating said surface to be treated while transporting said substrate to form said functional film; and then
re-adhering the thus treated substrate and said protective film to cover said surface to be treated with said protective film to form a re-adhered laminated material.

2. The method of manufacturing a functional film according to claim 1, wherein said treating step is a step of depositing on said surface to be treated of said substrate.

3. The method of manufacturing a functional film according to claim 1, wherein tension cutting means is disposed on a transporting path of said protective film between a peeling position where said protective film is peeled off from said substrate to a re-adhering position where said protective film is re-adhered to said substrate, and blocks tensile forces that act on the protective film in said transporting path before and after said tension cutting means is disposed.

4. The method of manufacturing a functional film according to claim 3, wherein the following expression (1) is satisfied
T3<T1<T2 (1)
where T1 denotes a tensile force acting on said substrate, T2 denotes a tensile force acting on said protective film from said peeling position to a position of said tension cutting means, and T3 denotes a tensile force acting on said protective film from said position of said tension cutting means to said re-adhering position.

5. The method of manufacturing a functional film according to claim 1,
wherein said treating step a step of treating said surface to be treated of said substrate under a reduced pressure;
wherein said protective film is transported in the longitudinal direction from said peeling position to said re-adhering position under the reduced pressure in said transporting step.

6. The method of manufacturing a functional film according to claim 5, wherein said treating step is a step of treating said surface to be treated of said substrate under a pressure of 1000 Pa or below.

7. The method of manufacturing a functional film according to claim 5, wherein a pressure in a transporting path of said protective film from said peeling position to said re-adhering position is the same as a treatment pressure of said surface to be treated of said substrate.

8. The method of manufacturing a functional film according to claim 1, further comprising adjusting a temperature of said protective film during transporting of said protective film.

9. The method of manufacturing a functional film according to claim 8, wherein said adjusting step is a step of adjusting said temperature of said protective film such that a temperature difference between said substrate and said protective film at said re-adhering position is 20° C. or less.

10. The method of manufacturing a functional film according to claim 1, wherein said re-adhering step is a step of re-adhering said substrate and said protective film while holding temperatures of said substrate and said protective film at or below their respective glass transition temperatures, respectively.

11. The method of manufacturing a functional film according to claim 1, wherein said peeling step is a step of peeling off said protective film from said substrate at or below a softening temperature of an adhesive material of said protective film.

12. The method of manufacturing a functional film according to claim 1, further comprising:
unwinding said laminated material from a substrate roll in which a web of said laminated material was wound into a roll to feed said laminated material to said peeling step; and
winding again into a roll said re-adhered laminated material transported from said re-adhering step,
wherein said peeling step of said substrate and said protective film of said fed laminated material, said treating step of said substrate, and said re-adhering step of said treated substrate and said protective film while transporting said substrate are performed and then said re-adhered laminated material is sent to said winding step.

13. The method of manufacturing a functional film according to claim 1, wherein said protective film is cleaned in said transporting path of said protective film by cleaning means of said protective film provided on said transporting path of said protective film.
